(19) United States
(12) Patent Application Publication
(10) Pub. No.: US 2009/0275112 A1
(43) Pub. Date: Nov. 5, 2009

(54) NUTRIENT ADDITIVES FOR START-UP AND SUSTAINED OPERATION OF A BIOLOGICAL FILTER APPARATUS

(75) Inventors: James T. Boswell, Montgomery, TX (US); Paul C. John, Beaverton, OR (US); Karl W. Mundorff, Portland, OR (US)

Correspondence Address: SMITH-HILL AND BEDELL, P.C., 16100 NW CORNELL ROAD, SUITE 220, BEAVERTON, OR, 97006, US

(73) Assignee: BIO-REACTION INDUSTRIES, LLC, Tualatin, OR (US)

(21) Appl. No.: 12/432,501

(22) Filed: Apr. 29, 2009

Related U.S. Application Data
(60) Provisional application No. 61/049,286, filed on Apr. 30, 2008.

(51) Int. Cl. B01D 53/84; A62D 3/02; C02F 3/00

(52) U.S. Cl. 435/262.5; 435/266

(57) ABSTRACT

A biological filter apparatus for biological degradation of contaminants in an air stream is operated by passing the air stream through a filter chamber containing a structure supporting a population of microbes and collecting water that drains from the structure and spraying the collected water onto the structure, whereby the sprayed water is recirculated. Upon start up or re-start of the filter apparatus, a nutrient composition is added to the recirculating water. The nutrient composition contains a buffering agent, sources of nitrogen and phosphorus, and sources of trace elements selected from manganese, calcium, iron and sodium.

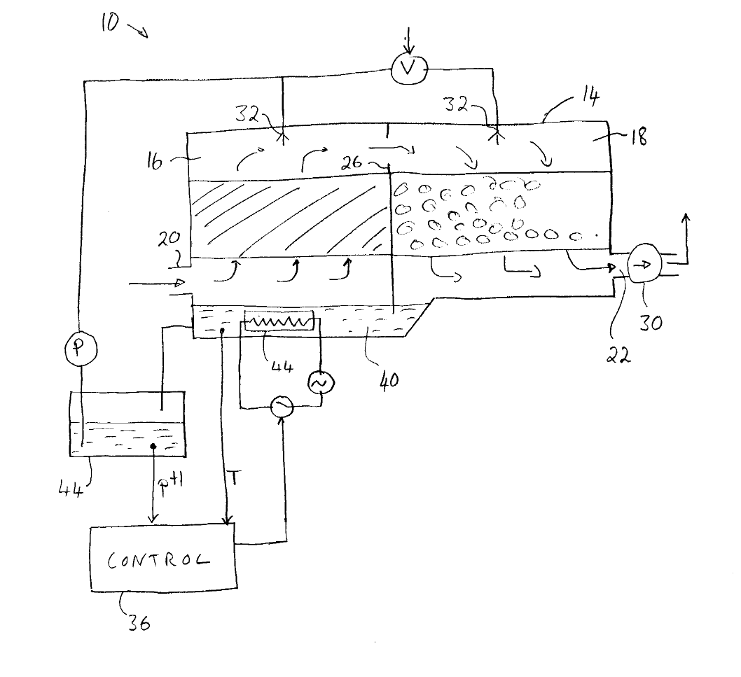

### CROSS-REFERENCE TO RELATED APPLICATION

This application claims benefit of Provisional Application No. 61/049,286 filed Apr. 30, 2008, the entire disclosure of which is hereby incorporated by reference herein for all purposes.

### BACKGROUND OF THE INVENTION

The subject matter of this application relates to nutrient additives for start-up and sustained operation of a biological filter apparatus, and to a method of operating a biological filter apparatus utilizing the nutrient additives.

An air stream emitted by an industrial or commercial source, such as a waste water treatment plant, a wood products plant or a paint and coating facility, may contain hazardous or noxious contaminants such as volatile organic compounds (VOCs), hazardous air pollutants (HAPs), odoriferous compounds, and organic particulates that should be removed from the air stream before discharging the airstream into the ambient atmosphere. Many of these contaminants can be removed, at least partially, from an air stream by biological degradation using a biological filter apparatus in which microorganisms convert the contaminants to compounds that may be discharged. For example, some microbes convert some VOCs to carbon dioxide and water.

Some of the contaminants that are processed by a biological filter apparatus are hydrophilic (highly water soluble) whereas others are hydrophobic (substantially less water soluble than hydrophilic contaminants).

A practical implementation of the biological filter apparatus disclosed in U.S. Pat. No. 6,479,276 comprises a biotrickling filter unit and a biomatrix unit connected in series, such that air laden with contaminants passes sequentially through the biotrickling filter unit and the biomatrix unit. The biotrickling filter unit contains an inert, cross-flow filter medium having a large surface area supporting a biofilm and presenting a relatively low resistance to the air flow whereas the biomatrix unit contains a filter matrix presenting a rather higher flow resistance. Preferably, the filter matrix in the biomatrix unit is a bed of ellipsoidal, preferably spherical, support elements having the structure described in U.S. Pat. No. 6,524,849. Each support element may form the core of a discrete body of plant compost, in which case the support element may be referred to as being full, or the interior space of the support element may be substantially devoid of plant compost, in which case the support element may be referred to as being empty. In either case, the support elements support a population of microbes.

In order to create a favorable environment for the action of the biological microorganisms, water is continuously sprayed from above onto the inert filter medium in the biotrickling filter unit and is sprayed periodically onto the filter matrix in the biomatrix unit. Water draining from the inert filter medium and the filter matrix is collected in a sump at the bottom of the biotrickling filter unit and is recirculated to the spray nozzles above the filter media in the two filter units. The water may be warmed by a heater located in the sump.

In the event that the support elements are full, the water that collects in the sump contains particles of compost from the biomatrix unit and may also contain dissolved nutrients from the biomatrix unit. Whether the support elements are empty or full, the water will also contain microorganisms from both the biomatrix unit and the biotrickling filter unit. By recirculating the water, microorganisms and possibly also particles of compost and dissolved nutrients are supplied to the inert filter medium in the biotrickling filter unit and to the biomatrix chamber.

Conditions in the biotrickling filter favor biodegradation of hydrophilic contaminants, whereas hydrophobic contaminants are degraded more effectively in the drier conditions of the biomatrix unit.

Some contaminants, such as many hydrophilic compounds, may biodegrade quite quickly, while others, such as hydrophobic compounds, may require more extensive biological processing, and thus a greater length of time for degradation. Due to the respective flow resistance characteristics of the inert filter medium and the biomatrix, the air passing through the filter apparatus resides for a substantially longer time in the biomatrix unit than in the biotrickling filter unit.

Since the water in the sump contains microorganisms, the water in the sump acts as an extended aeration wastewater treatment unit within the biological filter apparatus. Thus, in practice the filter apparatus provides three environments in which contaminants may be degraded through biological action.

It has been observed that the biological filter apparatus may operate less efficiently on first start up, or on re-start after being out of service for some time, for example four weeks or more, because the population of microorganisms is smaller than when the filter apparatus has been in operation for an extended, continuous period and a population of microorganisms has built up. It is known to accelerate the start up, or re-start, of a biological filter apparatus by introducing additional microorganisms into the filter apparatus in order to augment the population of microorganisms present in the filter apparatus.

### SUMMARY OF THE INVENTION

In accordance with a first aspect of the disclosed subject matter there is provided a method of operating a biological filter apparatus for biological degradation of contaminants in an air stream, comprising passing the air stream through a filter chamber containing a structure supporting a population of microbes, collecting water that drains from the structure and spraying the collected water onto the structure, whereby the sprayed water is recirculated, and upon start up or re-start of the filter apparatus, adding a nutrient composition to the recirculating water, said nutrient composition containing a buffering agent, sources of nitrogen and phosphorus, and sources of trace elements selected from manganese, calcium, iron and sodium.

In accordance with a second aspect of the disclosed subject matter there is provided a method of operating a biological filter apparatus for biological degradation of hazardous air pollutants in an air stream, comprising passing the air stream through a filter chamber containing a structure supporting a population of microbes, collecting water that drains from the structure and spraying the collected water onto the structure, whereby the sprayed water is recirculated, and adding a nutrient composition to the recirculating water, said nutrient composition containing a buffering agent, sources of nitrogen and phosphorus, and sources of trace elements selected from manganese, calcium, iron and sodium.

### BRIEF DESCRIPTION OF THE DRAWINGS

For a better understanding of the invention, and to show how the same may be carried into effect, reference will now be made, by way of example, to the accompanying drawings, the single FIGURE of which is a schematic sectional view of a biological filter apparatus that is operable by a method that embodies the subject matter disclosed in this application.

### DETAILED DESCRIPTION

The biological filter apparatus 10 shown in the drawing comprises a housing 14 that defines a biotrickling chamber 16 and a biomatrix chamber 18. The biotrickling chamber contains a cross-flow filter medium whereas the biomatrix chamber contains a bed of spherical support elements, as described above. The support elements, BioAIRSpheres™, referred to for brevity as bioballs, may be full or empty, or the bed may contain a mixture of full and empty bioballs. The housing 14 has an air inlet 20 entering the biotrickling chamber below the cross-flow filter medium and an air outlet 22 leaving the biomatrix chamber below the bed of bioballs. The dividing wall 26 between the two chambers is formed with an opening above the respective filter media. The air inlet may be connected to receive an air stream from a pollution source, such as a wood products plant, a wastewater treatment plant or a paint and coatings facility. A blower 30 induces a flow of air into the filter apparatus through the inlet opening, upward through the cross flow medium, downward through the bed of bioballs, and out through the outlet opening.

Spray nozzles 32 are mounted in the two chambers 16, 18 above the respective filter media. Pipes, valves and a pump are connected to supply water to the spray nozzles 32. A control unit 36 controls the pump and valves so that water is supplied continuously to the biotrickling chamber and periodically to the biomatrix chamber. Water that drains from the cross-flow medium and the bed of bioballs collects in a sump 40 beneath the cross-flow medium and is drawn from the sump by the pump for recirculating to the spray nozzles. The water in the sump may be maintained in a warm condition by a heater 44 that is controlled by the control unit 36 in response to a signal provided by a temperature measurement probe (not shown).

The cross-flow filter medium and the bed of bioballs contain a population of microbes that biodegrade VOCs in the air stream and produce water and carbon dioxide.

It has been found that in a practical implementation the filter apparatus operates well when the pH of the recirculating liquid is in the range from about 7 to about 8.8, i.e. neutral to slightly alkaline. By monitoring the pH of the liquid using a pH measurement probe and adding appropriate additives, the pH can be kept within the desired range.

As suggested above, upon initial start-up of the filter apparatus, or on restart of the filter apparatus after being out of service for an extended period, e.g. four weeks or more, the population of microbes in the filter apparatus may be rather lower than is necessary for optimum performance. Accordingly, it is desirable to encourage rapid growth of the microbe population under these circumstances. This may be achieved by supplying nutrients and other additives, such as trace elements, to the microbes upon start-up, or restart, of the filter apparatus. In addition, it may be desirable to supply nutrients and other additives to the microbes at other times in order to maintain or enhance populations, thereby increasing efficiency.

In order to facilitate supply of additives to the microbes in the filter media, a tote or tank 44 is plumbed into the recirculation line from the sump 40 of the biotrickling chamber, so that at least some of the recirculating water passes through the tote to the spray nozzles 32. Various additives may be placed in the tote and will then be delivered to the microbes in the filter media by the flow of recirculating water.

The nutrient additive formulation is specified below in Table A.

TABLE A

| | | |
|---|---|---|
| Sodium citrate [Na₃C₆H₅O₇•2H₂O] | 9.5 | grams |
| Ammonium sulfate [2(NH₄)SO₄] | 40.0 | grams* (for acid forming) |
| Manganese sulfate [MgSO₄•7H₂O] | 8.2 | grams |
| Calcium chloride [CaCl₂•2H₂O] | 4.7 | grams |
| Ferrous sulfate [FeSO₄•7H₂O] | 8.5 | grams |
| Sodium chloride [NaCl] | 65 | grams |
| Phosphate Buffer [KH₂PO₄] | 120 | grams |
| Ammonium nitrate [NH₄NO₃] | 140 | grams (optional) |
| Nutrient Broth [Difco (a standard | 400 | grams |
| C—N—H source for bacterial | | |
| cultures-dehydrated] | | |
| Compost Tea | 10 | gallons (about 38 liters) |

*Optional, depending on whether mixture is “acid-forming” or “non-acid forming”

Upon initial start-up or restart of a filter apparatus, a specific, calculated amount of the nutrient additive, Micro Nu, is added to the tote/tank per 1000 gallons (US) (about 3800 liters) of sump liquid to encourage rapid growth of the microbe population and a smaller quantity (indicated below) is added periodically as needed, for example about once per week, during continuing operation to maintain the health and size of the microbe population. In each case, various optional ingredients may be added to the basic additive mix for specific purposes.

The nutrient additive is formulated for use with a filter apparatus in which the bioballs are either empty or full. Accordingly, there might not be sufficient carbon available to the microbes from the filter units with empty bioballs to encourage growth of the microbe population. Thus, a greater amount of additive mix may be added for additional carbon sources, which are not needed in the case of the bioballs being full, in the form of a compost tea and a nutrient broth. The compost tea may be made by immersing an infusion bag containing commercially available organic compost in water (one part compost to two parts water by volume) for five days at about 16 to 38° C. Preferably, 10 gallons (US) (about 38 liters) of the compost tea are added to the tote. The nutrient broth may be a commercially available broth used for bacterial cultures and available in dehydrated form.

In the event that the bioballs are full, the biomatrix chamber will generally contain sufficient carbon in the plant compost and additional carbon is not necessary.

The additive mix is formulated to provide optimum conditions for growth and health of the microbe population in the filter apparatus. As noted above, it is desirable that the pH of the liquid remain within a relatively narrow range, from about 7 to about 8.5. Sodium citrate is included in both as a carbon source and to also assist to moderate changes in pH of the recirculating liquid. Manganese sulfate, calcium chloride, ferrous sulfate and sodium chloride are sources of trace elements that are important to good health of the microbe population. The calcium chloride is also useful for pH management. Monopotassium phosphate and ammonium nitrate are important nutrients, and the monopotassium phosphate also serves as a buffer. Ammonium nitrate is provided as an additional nitrogen source to encourage rapid growth of the microbe population.

There are two versions of the additive mix, depending on whether the particular application tends to make the sump liquid more alkaline. In the event that the biological process would tend to increase the pH of the sump liquid, ammonium sulfate is included in the additive mix to reduce the alkalinity of the sump liquid. The ammonium sulfate also serves as a nutrient.

For different applications, the basic composition may be augmented by other additives. For some applications in which odor control and combined VOC and HAP control are desired, it has been found that it is generally unnecessary to include ammonium sulfate as the recirculating liquid does not become excessively alkaline. In other applications, in which only VOC control is desired, the recirculating liquid may become excessively alkaline and accordingly it is desirable to include additional ammonium sulfate in the additive mix.

In many applications improved operation results if a compost steeping bag containing 20 lbs (about 9.1 kg) of plant compost is placed in the tote/tank and replaced weekly. Nutrients and leachates from the compost are infused into the recirculating sump water. In addition, for initial start-up and restart, 0.25 lbs (about 110 g) of sodium carbonate (a buffering agent) and 0.10 lbs (about 45 g) of freeze dried aerobic microbes may be added to the basic additive composition.

In the case of a biofilter apparatus used to remove VOCs and HAPs from an air stream from a wood product plant, initial start-up and restart can be aided if the additive mixture is augmented with about 0.5 to 1.5 lbs (wet weight) (about 0.23 to 0.68 kg) of beer mash per 10,000 gallons (about 38,000 liters) of sump water. In the case of a filter apparatus used to remove VOCs from an air stream, particularly an air stream from a paint and coatings facility, initial start-up and restart are aided if the additive is augmented not only with about 0.5 to 1.5 lbs (wet weight) of beer mash per 10,000 gallons of sump water but also with 0.5 to 1.0 gallons (about 1.9 to 3.8 liters) of alcohol (ethanol or methanol) per 10,000 gallons of sump water.

To provide additional organic carbon for rapid start-up of the bio-oxidation system a pelletized, vegetable meal based addition may be added twice monthly at the rate of approximately 0.25 lb (0.13)kg per ft² (0.09 m²) of the biomatrix chamber. This additional organic carbon source is rapidly decomposed and the carbon utilized by the bacteria and fungi for enhanced population growth and increased speed of biofilm development.

During continuing operation of the filter apparatus, the tote/tank is periodically re-charged with the appropriate additive mix, usually weekly. The quantity added to the tote (a complete unit or a smaller quantity) and the interval between additions (typically about one week but possibly a shorter or longer interval) depend on conditions in the biofilter apparatus.

It has been found that addition of nutrients, as described above, is useful not only for start up and re-start of a biological filter apparatus that is used for control of contaminants, particularly VOCs, but also for continued operation of certain filters used for control of VOCs and HAPs. Thus, particularly in the case of a filter apparatus without plant compost, e.g. with empty bioballs, periodic addition of the nutrient mixture helps to maintain an adequate microbe population.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. For example, although the invention has been described in the context of a filter apparatus in which the air flow passes upward through the biotrickling filter unit and downward through the biomatrix chamber, other air flow patterns are possible and in particular the filter apparatus may be configured so that the air flow passes upward through the biomatrix chamber. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A method of operating a biological filter apparatus for biological degradation of contaminants in an air stream, comprising:
passing the air stream through a filter chamber containing a structure supporting a population of microbes,
collecting water that drains from the structure and spraying the collected water onto the structure, whereby the sprayed water is recirculated, and
upon start up or re-start of the filter apparatus, adding a nutrient composition to the recirculating water, said nutrient composition containing a buffering agent, sources of nitrogen and phosphorus, and sources of trace elements selected from manganese, calcium, iron and sodium.

2. A method according to claim 1, wherein the nutrient composition contains sodium citrate, potassium phosphate and ammonium nitrate.

3. A method according to claim 1, wherein the nutrient composition comprises manganese sulfate, calcium chloride, ferrous sulfate and sodium chloride.

4. A method according to claim 1, wherein the nutrient composition comprises, by weight, 9.5 parts sodium citrate, 8.2 parts manganese sulfate, 4.7 parts calcium chloride, 8.5 parts ferrous sulfate, 65 parts sodium chloride, and 120 parts monopotassium phosphate.

5. A method of operating a biological filter apparatus for biological degradation of hazardous air pollutants in an air stream, comprising:
passing the air stream through a filter chamber containing a structure supporting a population of microbes,
collecting water that drains from the structure and spraying the collected water onto the structure, whereby the sprayed water is recirculated, and
adding a nutrient composition to the recirculating water, said nutrient composition containing a buffering agent, sources of nitrogen and phosphorus, and sources of trace elements selected from manganese, calcium, iron and sodium.

6. A method according to claim 5, wherein the nutrient composition contains sodium citrate, potassium phosphate and ammonium nitrate.

7. A method according to claim 5, wherein the nutrient composition comprises manganese sulfate, calcium chloride, ferrous sulfate and sodium chloride.

8. A method according to claim 5, wherein the nutrient composition comprises, by weight, 9.5 parts sodium citrate, 8.2 parts manganese sulfate, 4.7 parts calcium chloride, 8.5 parts ferrous sulfate, 65 parts sodium chloride, and 120 parts monopotassium phosphate.

9. A method according to claim 5, wherein the nutrient composition further comprises a source of carbon.
